(19) United States
(12) Patent Application Publication
(10) Pub. No.: US 2006/0143916 A1
(43) Pub. Date: Jul. 6, 2006

(54) Method for fabricating wick microstructures in heat pipes

(75) Inventors: Ming-Jye Tsai, Zhubei City (TW); Jin-Cherng Shyu, Neipu Shiang (TW); Cheng-Tai Chou, Xinzhuang City (TW); Chia-Sheng Chiang, Xihu Town (TW); Lan-Kai Yeh, Kaohsiung City (TW); Shao-Wen Chen, Fengyuan City (TW)

Correspondence Address: BRUCE H. TROXELL;SUITE 1404, 5205 LEESBURG PIKE, FALLS CHURCH, VA, 22041, US

(73) Assignee: Industrial Technology Research Institute

(21) Appl. No.: 11/132,220

(22) Filed: May 19, 2005

(30) Foreign Application Priority Data
Dec. 31, 2004 (TW) 93141692

(51) Int. Cl. B23P 6/00

(52) U.S. Cl. 29/890.032

(57) ABSTRACT

The invention provides a method for fabricating wick microstructures in heat pipes, comprising the following steps: providing a flat plate and a mold with several molding holes; filling a powder material in the several molding holes and putting the mold to cover the flat plate so as to form an object to be sintered; sintering the object; and removing the mold to form a flat plate with wick microstructures. The wick microstructures are arranged on the flat plate in a form of microgrooves, microcylinders or any combination of them. The flat plate with wick microstructures is further processed to form a heat pipe with a characteristic shape and having two kinds of wick microstructures such that the heat transferred by the heat pipe is increased and the occurrence of dry out of the heat pipe is delayed.

### FIELD OF THE INVENTION

The present invention relates to a method for fabricating wick microstructures in heat pipes, more particularly to a method for fabricating wick microstructures in heat pipes, in which the wick microstructures are arranged in any size on any area of inner surface of heat pipes by sintering.

### BACKGROUND OF THE INVENTION

As time goes by, heat generated in each unit electronic component is increasing. Besides, miniaturizing of electronic packages and integrating more functions into a microsystem are occurring simultaneously. Thus, the density of giving out heat in electronic components is higher and higher such that thermal management is more and more difficult. If thermal management of an electronic system is not good, increased junction temperature will cause decreased clock speed and operation efficiency, even a shortened usage life of the electronic component. Therefore, thermal management of electronic components is becoming a key issue concerned by electronic product manufacturers.

In addition, when heat given out by electronic components such as CPU of a personal computer is increased, a difficult problem of heat being not uniformly given out is accompanied simultaneously thus hot spots will be formed on surfaces of the electronic components. For solving this problem, many methods of dissipating heat are proposed for electronic products of the present and the next generations. Among those methods, heat pipe is one of the most widely accepted schemes because of its features of no need for external power, low price, and light weight.

In heat pipes, the most important design is to concern, in the processes of vaporization and condensation of internal fluids, how to effectively utilize wick structures for guiding condensed fluids to the vaporizing terminal and avoiding the fluid flowing channel from being blocked by boiling bubbles so as to successfully remove larger heat. The followings are some conventional heat dissipating techniques:

(1) sintered wick structures: (a) U.S. Pat. No. 4,274,479 disclosing wick structures in heat pipes by using sintered grooves, wherein the grooves may be made in any desired crossectional configuration. Thus, the wick structures on inner surface of the heat pipe are in the shapes of groove or others and are longitudinally extended along the heat pipe. Besides, the bottom of each groove forms a continuous layer for providing lateral flowing passage for working fluids. However, the bottoms of the sintered wick structures are connected to form a continuous layer so that it will form an obstacle when boiling bubbles escape. (b) U.S. Pat. No. 5,076,352 disclosing a capillary structure formed of at least two layers of perforated material separated by granules of powdered material so as to increase permeability of the wick structure.

(2) grooved wick structures: Taiwan Patent Publication No. 528,151 disclosing a multiple-layer wick structure comprising an externally sealed container and an inner container in heat pipes, wherein grooves are arranged around the containers to form the wick structure.

To sum up, it is known that conventional wick structures in heat pipes can be sorted into sintered ones and grooved ones. Although grooved wick structures operate horizontally can remove huge heat, the heat removed will decreases rapidly once a tilting angle occurs when the heat pipe operates because the capillary pumping of grooved wick structures is not strong.

On the other hand, the heat removed by sintered wick structures will not be large since its feature of small aperture causes a larger flowing resistance. In addition, the sintered structures also cause that boiling bubbles of the working fluids can not escape from the sintered structures easily so that its performance is influenced.

In view of the above-mentioned problems, a wick structure including advantages of both of those two structures will greatly improve the performance of heat pipes. Therefore, a method for fabricating wick microstructures in heat pipes is required to achieve that boiling bubbles in heat pipes can escape from the wick structures easily, the results of operating at an angle are better, and arrangement of the wick structures in heat pipes can be designed, so as to improve the performance of heat pipes.

### SUMMARY OF THE INVENTION

The primary objective of the present invention is to provide a method for fabricating wick microstructures in heat pipes, which utilizes sintering and processing a flat plate to form two wick microstructures such that the heat transferred is increased.

The secondary objective of the present invention is to provide a method for fabricating wick microstructures in heat pipes, in which a mold with several molding holes is utilized to control arrangements and sizes of the sintered microstructures on the surfaces of heat pipes such that the heat transferred is increased.

Another objective of the present invention is to provide a method for fabricating wick microstructures in heat pipes, in which a mold with several molding holes is utilized to control arrangements and sizes of the sintered microstructures on the surfaces of heat pipes such that the occurrence of dry out of heat pipes is delayed.

To achieve the foregoing objectives, the present invention provides a method for fabricating wick microstructures in heat pipes, comprising the following steps: providing a flat plate and a mold with several molding holes; filling a powder material in the several molding holes and putting the mold to cover the flat plate so as to form an object to be sintered; sintering the object; and removing the mold to form a flat plate with wick microstructures. The wick microstructures are arranged on the flat plate in a form of microgrooves, microcylinders or any combination of them. The flat plate with wick microstructures is further processed to form a heat pipe with a characteristic shape and having two kinds of wick microstructures such that the heat transferred by the heat pipe is increased and the occurrence of dry out of the heat pipe is delayed.

Preferably, the method of the present invention further comprises a step of processing the flat plate with wick microstructures to form a heat pipe. The manner of processing can be rolling up or folding up.

To make the examiner easier to understand the objectives, structure, innovative features, and function of the invention, preferred embodiments together with accompanying drawings are illustrated for the detailed descriptions of the invention.

### BRIEF DESCRIPTION OF THE DRAWINGS

FIG. 1 is a diagram showing relations of heat transfer capability and tilting angle of various wick structures when depth of the wick structures is 1.0 mm.

FIG. 2 is a flow chart of a method for fabricating wick microstructures in heat pipes of a first preferred embodiment of the present invention.

FIGS. 3A-3E are cross sectional diagrams depicting the procedures of a method for fabricating wick microstructures in heat pipes of a first preferred embodiment of the present invention.

FIG. 4 is a diagram showing the molding holes utilized in a method of the present invention for fabricating wick microstructures in heat pipes.

FIG. 5 is a cross sectional diagram depicting a flat plate with wick microstructures of a first preferred embodiment of the present invention.

FIG. 6A is a diagram of a flat plate with wick microstructures in a method of the present invention for fabricating wick microstructures in heat pipes.

FIG. 6B is a cross sectional diagram depicting wick microstructures in heat pipes of a second preferred embodiment of the present invention.

FIG. 6C is a diagram showing wick microstructures in a method for fabricating wick microstructures in heat pipes of a second preferred embodiment of the present invention.

FIGS. 7A-7B are cross sectional diagrams depicting preferred embodiments of heat pipes formed by methods of the present invention for fabricating wick microstructures in heat pipes.

FIGS. 8A-8B are stereograms depicting another preferred embodiments of heat pipes formed by methods of the present invention for fabricating wick microstructures in heat pipes.

### DESCRIPTION OF THE PREFERRED EMBODIMENT

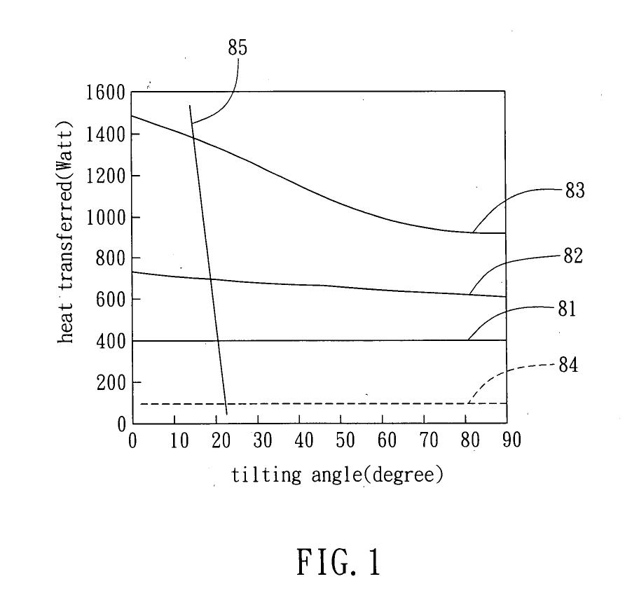

FIG. 1 is a diagram showing relations of heat transfer capability and tilting angle of various wick structures when depth of the wick structures is 1.0 mm. In FIG. 1, curve 81 represents a grooved wick microstructure sintered with powders having a diameter of 50 μm by the method of the present invention, curve 82 represents a grooved wick microstructure sintered with powders having a diameter of 100 μm by the method of the present invention, and curve 83 represents a grooved wick microstructure sintered with powders having a diameter of 200 μm by the method of the present invention. Curve 84 represents a simply sintered wick structure with no particular shape, which is merely sintered with a layer of powders, and curve 85 represents an ordinary grooved wick structure. It can be found in FIG. 1 that heat transferred by the wick structure of curve 84 when operated with a tilting angle will not be influenced much since this kind of wick structure has smaller apertures such that the capillary pumping thereof is very strong. However, its feature of small apertures causes a larger flowing resistance thus heat transferred by this kind of wick structure is not large. In addition, due to the property of sintered structures, boiling bubbles of the working fluids can not escape from the sintered structures easily so that its performance is influenced. On the other hand, huge heat can be transferred by the wick structure of curve 85 when operated horizontally because boiling bubbles of the working fluids can escape from this kind of sintered structure very easily and will not cause any flowing resistance for the working liquids in heat pipes. However, the heat transferred will decreases rapidly once a tilting angle occurs when the heat pipe operates because the capillary pumping of grooved wick structures is not strong. Therefore, grooved wick structures are suitable for transferring heat in large watts with little tilting angle or in an environment not affected by gravity.

On the contrary, the wick structure formed by the present invention includes advantages of both of those two above-mentioned wick structures will definitely improve the performance of heat pipes as shown in curves 81, 82, and 83. It also can be found in FIG. 1 that the heat transferred increases when the diameter of powders for forming the sintered wick structures increases, e.g. curve 83. Further, when the tilting angle increases, the heat transferred by the structures of the present invention are better than those by the wick structures as shown in curves 84 and 85.

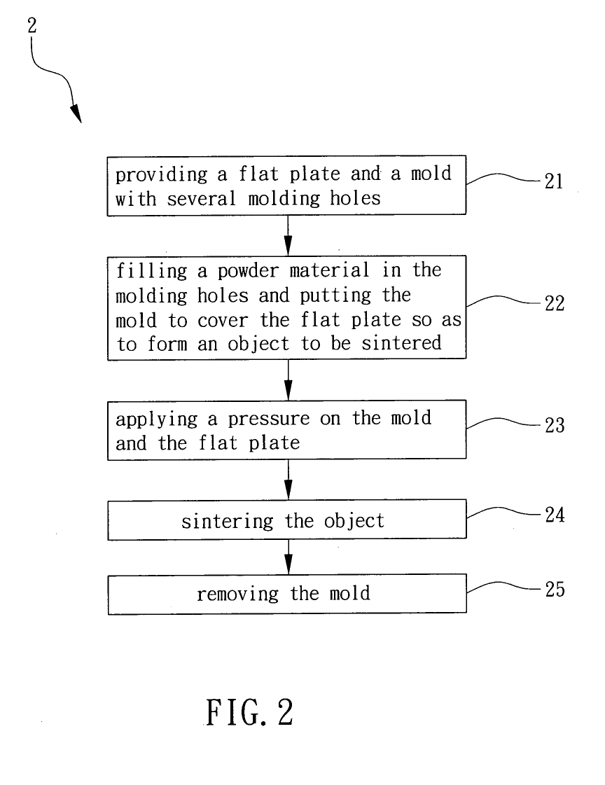

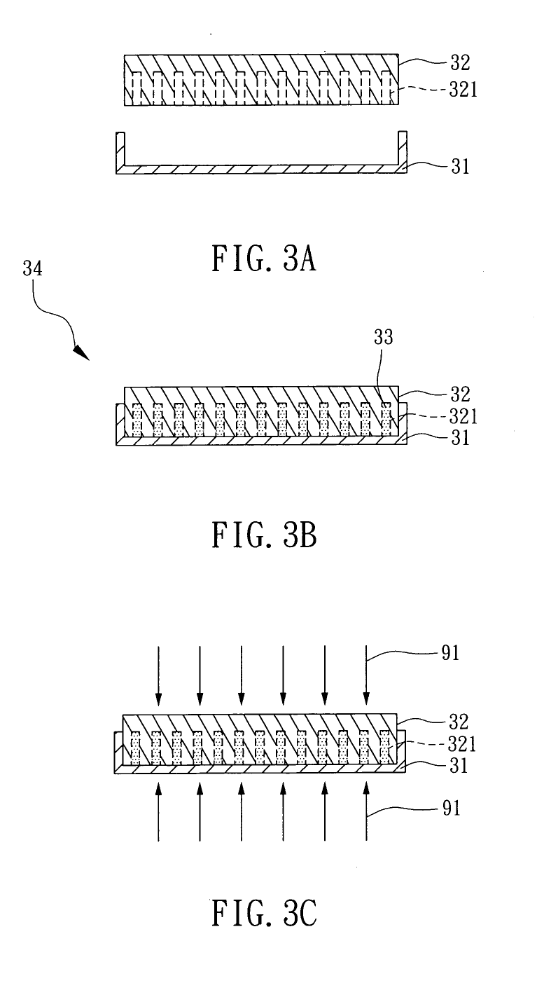

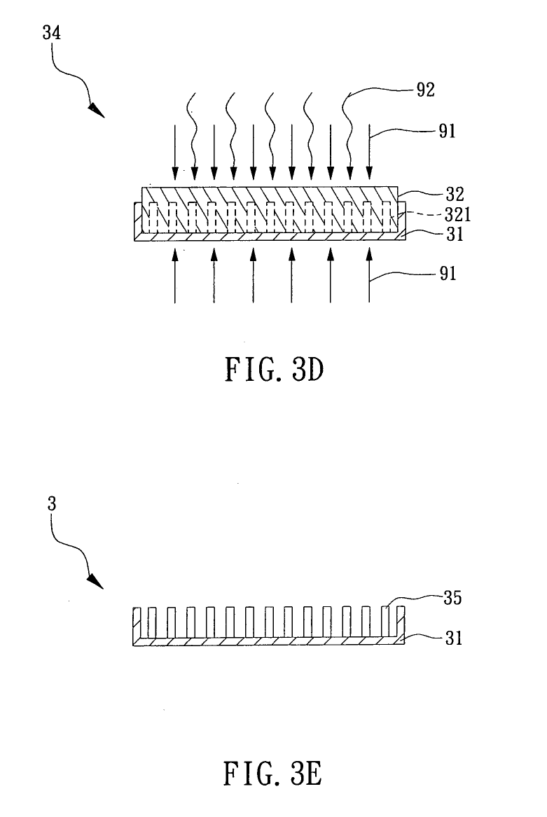

Please refer to FIG. 2 and FIGS. 3A-3E, wherein FIG. 2 is a flow chart of a method for fabricating wick microstructures in heat pipes of a first preferred embodiment of the present invention and FIGS. 3A-3E are cross sectional diagrams depicting the procedures of a method for fabricating wick microstructures in heat pipes of a first preferred embodiment of the present invention. Based on those figures, the invention provides a method for fabricating wick microstructures in heat pipes, comprising the following steps:

step 21: providing a flat plate 31 and a mold 32 with several molding holes 321 (as shown in FIG. 3A);

step 22: filling a powder material 33 in the several molding holes 321 and putting the mold 32 to cover the flat plate 31 so as to form an object 34 to be sintered (as shown in FIG. 3B);

step 23: applying a pressure 91 on the mold 32 and the flat plate 31 (as shown in FIG. 3C);

step 24: sintering the object 34 by a high-temperature sintering 92 (as shown in FIG. 3D); and

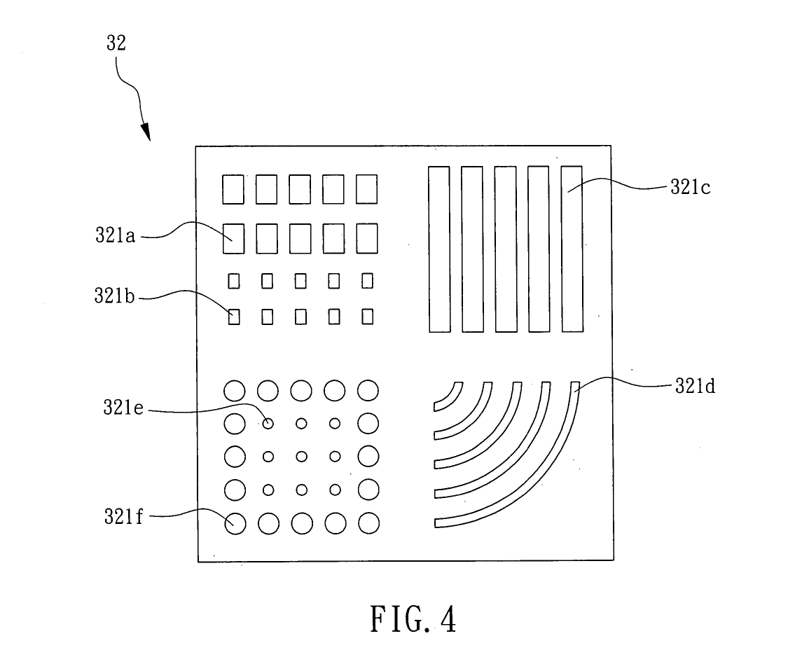

step 25: removing the mold 32 to form a flat plate 3 with wick microstructures (as shown in FIG. 3E).

Wherein, there are several sintered bodies 35 formed on the flat plate 3 with wick microstructures. The powder material can be metal powder or ceramic powder and the shape of the powder material can be a sphere, a tree branch, or a combination of them. Referring to FIG. 4, which is a diagram showing the molding holes utilized in a method of the present invention for fabricating wick microstructures in heat pipes. The outer contour of the molding holes can be a circle, a rectangle, a triangle, other geometric shapes, or a combination of them. In FIG. 4, the mold 32 having molding holes 321a, 321b, 321c, 321d, 321e, and 321f with various shapes.

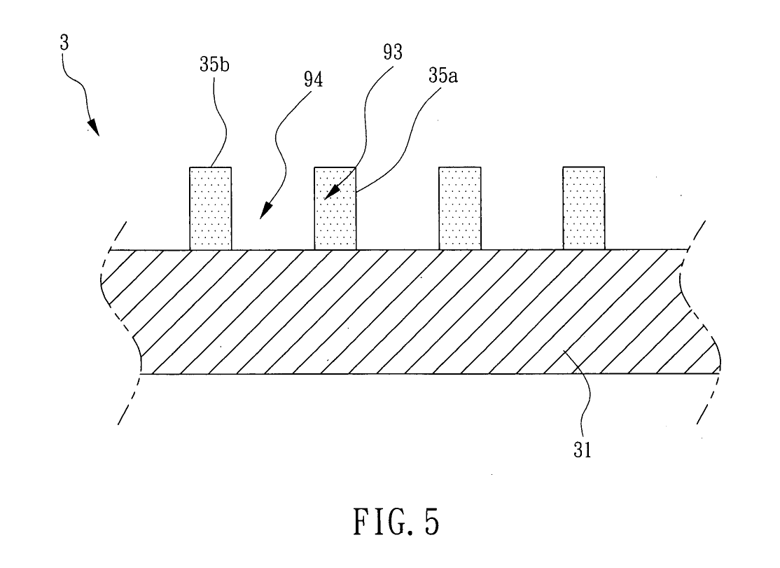

Please refer to FIG. 5, which is a cross sectional diagram depicting a flat plate with wick microstructures of a first preferred embodiment of the present invention. In FIG. 5, the sintered bodies 35a, 35b and the flat plate 31 form two wick structures 93 and 94 on the flat plate 31 with wick microstructures, wherein the wick structure 93 is one formed by apertures contained in the sintered body 35a itself and the wick structure 94 is one formed by the gap between the adjacent sintered bodies 35a, 35b and the flat plate 31. By the combination of these two wick structures, the heat transferred by a heat pipe is increased and the performance shown on curve 83 of FIG. 1 can be achieved.

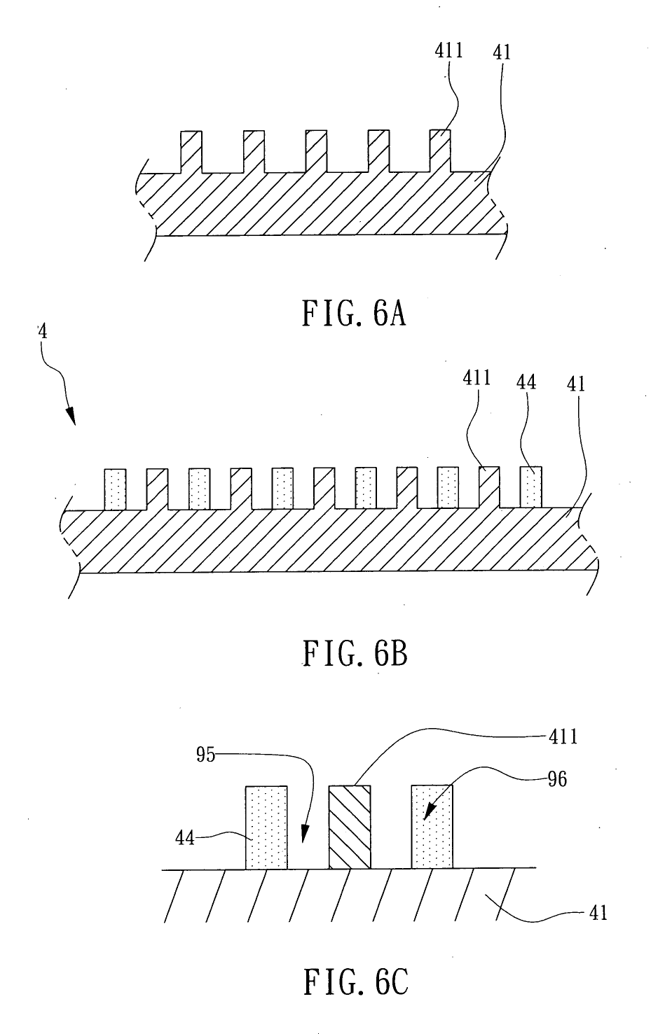

FIG. 6A is a diagram of a flat plate with wick microstructures in a method of the present invention for fabricating wick microstructures in heat pipes. In the embodiment, several microstructures 411 are previously formed on the flat plate 41 by further processing and the microstructures 411 are protruding bodies. FIG. 6B is a cross sectional diagram depicting wick microstructures in heat pipes of a second preferred embodiment of the present invention. A flat plate 4 with wick microstructures can be formed by the flat plate 41 of the embodiment and the flow shown in FIGS. 3A-3E, wherein there are several microstructures 411 and several bodies 44 sintered by a powder material on the flat plate 41. FIG. 6C is a diagram showing wick microstructures in a method for fabricating wick microstructures in heat pipes of a second preferred embodiment of the present invention. In FIG. 6C, there are two different wick structures 95 and 96 on the flat plate 4 with wick microstructures, wherein the wick structure 95 is one formed by the gap between the microstructure 411 and the sintered body 44 and the wick structure 96 is one formed by apertures contained in the sintered body 44 itself. By the spirit of the present invention, several kinds of wick structures can be formed thereon to enhance the performance of heat transferring of a heat pipe.

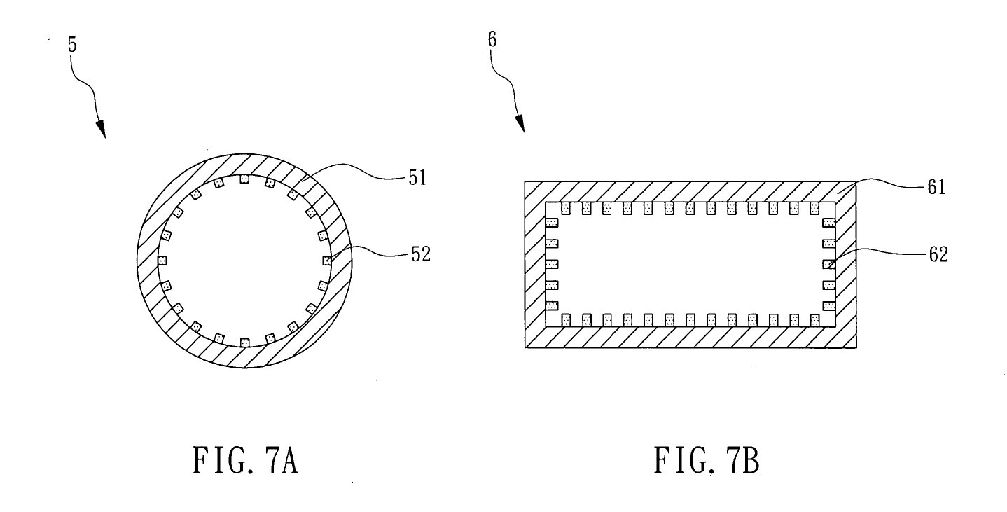

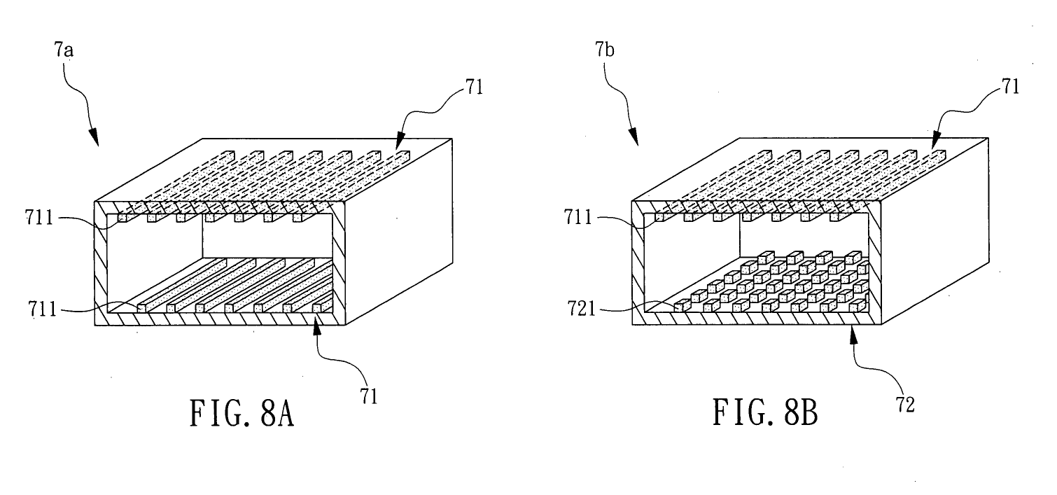

The flat plates with wick microstructures fabricated by the present invention as shown in FIG. 5 and FIG. 6B can be further processed to form a heat pipe. FIGS. 7A-7B are cross sectional diagrams depicting preferred embodiments of heat pipes formed by methods of the present invention for fabricating wick microstructures in heat pipes. The manner of processing can be rolling up or folding up. The cross sectional contour of the heat pipe can be a triangle, a rectangle, a circle or other geometrical shapes. In FIG. 7A, a circular heat pipe 5 is formed by rolling up a flat plate 51 with several sintered bodies 52. In FIG. 7B, a rectangular heat pipe 6 is formed by folding up a flat plate 61 with several sintered bodies 62. Further, FIGS. 8A-8B are stereograms depicting another preferred embodiments of heat pipes formed by methods of the present invention for fabricating wick microstructures in heat pipes. In FIG. 8A, a rectangular heat pipe 7a is formed by soldering or other techniques to combine at least two flat plates 71 with sintered bodies 711, wherein the sintered bodies on the two flat plates are microstructures of the same kind. In FIG. 8B, a rectangular heat pipe 7b is formed by combining at least two flat plates 71 and 72 with different microstructures of sintered bodies 711 and 721, respectively.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method for fabricating wick microstructures in heat pipes, comprising the following steps:
providing a flat plate and a mold with several molding holes;
filling a powder material in the several molding holes and putting the mold to cover the flat plate so as to form an object to be sintered;
sintering the object; and
removing the mold to form a flat plate with wick microstructures.

2. The method for fabricating wick microstructures in heat pipes of claim 1, wherein a pressure is applied on the mold and the flat plate in the step of sintering.

3. The method for fabricating wick microstructures in heat pipes of claim 1, wherein the powder material is metal powder.

4. The method for fabricating wick microstructures in heat pipes of claim 1, wherein the powder material is ceramic powder.

5. The method for fabricating wick microstructures in heat pipes of claim 1, wherein the shape of the powder material can be a sphere, a tree branch, or a combination of them.

6. The method for fabricating wick microstructures in heat pipes of claim 1, wherein there are several microstructures formed on the flat plate.

7. The method for fabricating wick microstructures in heat pipes of claim 6, wherein the microstructures are protruding bodies.

8. The method for fabricating wick microstructures in heat pipes of claim 1, wherein the outer contour of the molding holes can be a circle, a rectangle, a triangle, other geometric shapes, or a combination of them.

9. The method for fabricating wick microstructures in heat pipes of claim 1, further comprising a step of processing the flat plate with wick microstructures to form a heat pipe.

10. The method for fabricating wick microstructures in heat pipes of claim 9, wherein the cross sectional contour of the heat pipe can be a triangle, a rectangle, a circle or other geometrical shapes.

11. The method for fabricating wick microstructures in heat pipes of claim 9, wherein the manner of processing can be rolling up or folding up.

12. The method for fabricating wick microstructures in heat pipes of claim 9, wherein the manner of processing can be soldering at least two flat plates with the same wick microstructures to form the heat pipe.

13. The method for fabricating wick microstructures in heat pipes of claim 9, wherein the manner of processing can be soldering at least two flat plates with different wick microstructures to form the heat pipe.
